(19) United States
(12) Patent Application Publication
(10) Pub. No.: US 2025/0303698 A1
(43) Pub. Date: Oct. 2, 2025

(54) IMAGE FORMING APPARATUS

(71) Applicant: KYOCERA Document Solutions Inc., Osaka (JP)

(72) Inventor: Shotaro Ikegami, Osaka (JP)

(21) Appl. No.: 19/073,912

(22) Filed: Mar. 7, 2025

(30) Foreign Application Priority Data
Mar. 26, 2024 (JP) 2024-048954

(51) Int. Cl. B41J 2/045

(52) U.S. Cl. CPC B41J 2/0457; B41J 2/04548; B41J 2/04573; B41J 2/04581

(57) ABSTRACT

An image forming apparatus includes a head unit, and a switching power supply. The head unit is configured to eject ink. The switching power supply is configured to supply electric power to the head unit. Further, the head unit includes an actuator unit to eject ink; and the switching power supply operates with a switching frequency different from a natural vibration frequency of the actuator unit.

### CROSS-REFERENCE TO RELATED APPLICATIONS

This application relates to and claims priority rights from Japanese Patent Application No. 2024-048954, filed on Mar. 26, 2024, the entire disclosures of which are hereby incorporated by reference herein.

### BACKGROUND

### 1. Field of the Present Disclosure

The present disclosure relates to an image forming apparatus.

### 2. Description of the Related Art

An electronic apparatus includes plural DC/DC converters, and switching frequencies of the plural DC/DC converters are set as frequencies that do not make resonance with each other.

An inkjet-type image forming apparatus include a head unit that ejects ink, and the head unit includes a piezoelectric element as an actuator to eject ink. Such piezoelectric element has a mechanical natural vibration frequency; and when a switching power supply is used as a power supply to supply electric power to the head unit, if a switching frequency of the switching power supply is substantially identical to the natural vibration frequency of the switching power supply, then resonance may occur with the piezoelectric element and consequently malfunction may occur.

### SUMMARY

An image forming apparatus according to an aspect of the present disclosure includes a head unit, and a switching power supply. The head unit is configured to eject ink. The switching power supply is configured to supply electric power to the head unit. Further, the head unit includes an actuator unit to eject ink; and the switching power supply operates with a switching frequency different from a natural vibration frequency of the actuator unit.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an image forming apparatus according to an embodiment of the present disclosure;

FIG. 2 shows a block diagram that indicates an example of a video circuit board 2 shown in FIG. 1;

FIG. 3 shows a block diagram that indicates an example of a head unit 3 shown in FIG. 1; and

FIG. 4 shows a perspective-view diagram that indicates an example of an actuator unit 31 shown in FIG. 3.

### DETAILED DESCRIPTION

Hereinafter, an embodiment according to an aspect of the present disclosure will be explained with reference to drawings.

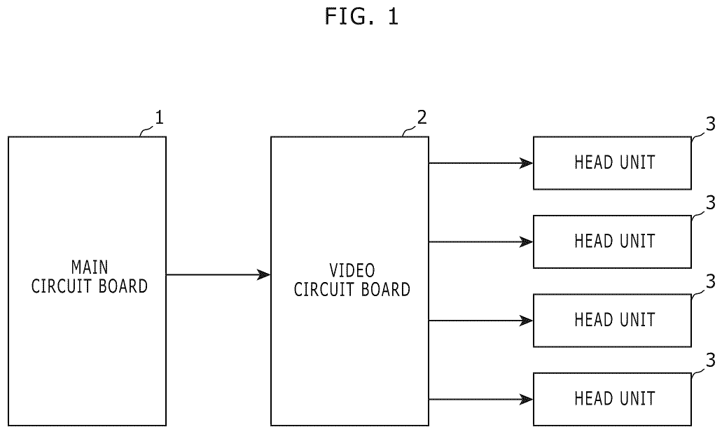

FIG. 1 shows a block diagram that indicates a configuration of an image forming apparatus according to an embodiment of the present disclosure. The image forming apparatus shown in FIG. 1 includes a main circuit board 1, a video circuit board 2, and one or plural head units 3 for one or plural ink colors. For example, if ink of four colors is used for printing, four head units 3 are installed.

The main circuit board 1 performs a predetermined image process and thereby generates image data of a page image. The video circuit board 2 supplies a video signal corresponding to the image data to each head unit 3 and thereby causes it to eject the ink correspondingly to the page image. Further, the video circuit board 2 supplies electric power to each head unit 3.

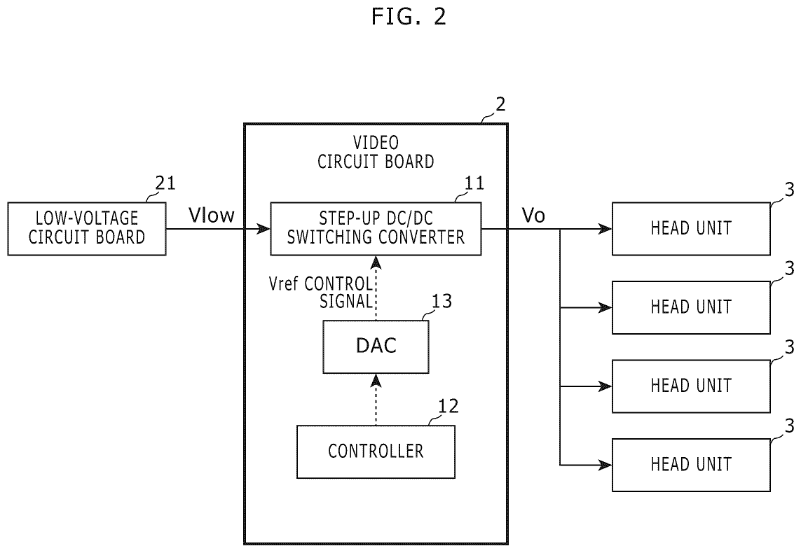

FIG. 2 shows a block diagram that indicates an example of the video circuit board 2 shown in FIG. 1. As shown in FIG. 2 for example, the video circuit board 2 includes a step-up DC/DC switching converter 11, a controller 12, and a digital analog converter (DAC) 13.

The step-up DC/DC switching converter 11 is a switching power supply and outputs direct-current electric power with a specified power supply voltage. The controller 12 is a processor such as CPU (Central Processing Unit) that operates in accordance with a control program, and sets a power supply voltage to the step-up DC/DC switching converter 11 through the DAC 13.

Specifically, direct-current electric power is inputted with a predetermined output voltage Vlow (e.g. 24V) from a low-voltage circuit board 21 into the step-up DC/DC switching converter 11, and direct-current electric power is outputted from the step-up DC/DC switching converter 11 with an output voltage Vo (e.g. any voltage in a range from 24V to 42V) specified by the controller 12.

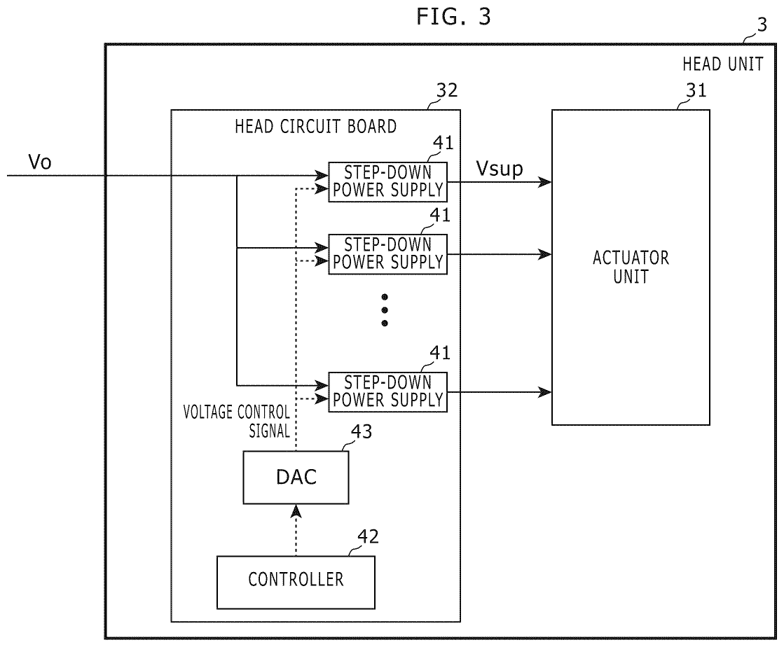

FIG. 3 shows a block diagram that indicates an example of the head unit 3 shown in FIG. 1. As shown in FIG. 3 for example, the head unit 3 includes an actuator unit 31 and a head circuit board 32.

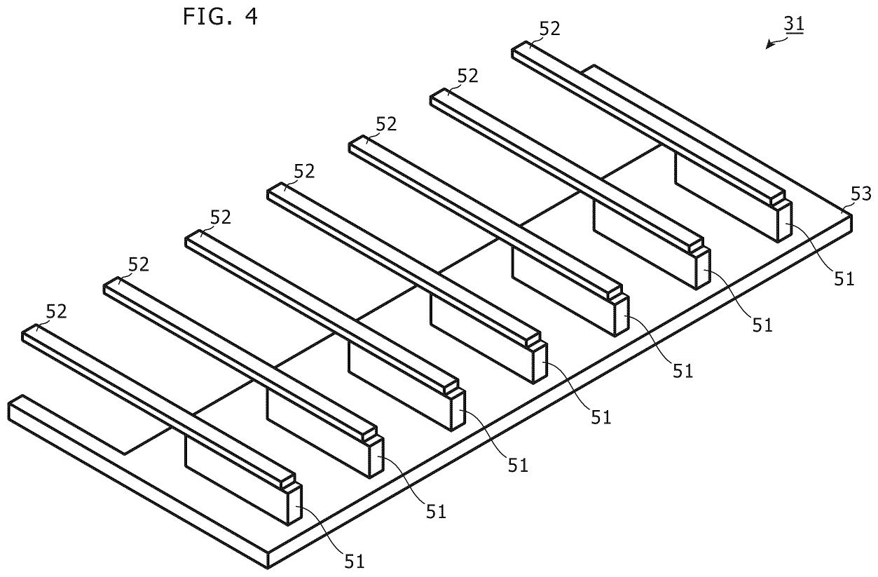

FIG. 4 shows a perspective-view diagram that indicates an example of the actuator unit 31 shown in FIG. 3. As shown in FIG. 4 for example, the actuator unit 31 includes a piezoelectric element 51 as an actuator to eject ink onto a print sheet or the like correspondingly to an image to be printed, and electrodes 52 and 53 connected to the piezoelectric element 51, and the actuator unit 31 has a natural vibration frequency on based a mechanical configuration of the piezoelectric element 51 and the electrodes 52 and 53. For example, the piezoelectric element 51 and the electrodes 52 and 53 has a microscopic structure in a range from a few micrometers to a few hundred micrometers; and in case of a few tens micrometers, the natural vibration frequency falls into a range of 2 MHz to 3 MHz. The electrodes 52 are electrodes respectively for the piezoelectric elements 51, and the electrode 53 is an electrode common to the piezoelectric elements 51.

Returning to FIG. 3, the head circuit board 32 includes plural step-down power supplies 41, a controller 42, and a digital analog converter (DAC) 43. The step-down power supplies 41 are linear converters that supply direct-current electric power to the actuator units 31 with specified output voltages Vsup (e.g. any voltages in a range from 16V to 40V), respectively. The controller 42 is a processor such as CPU that operates in accordance with a control program, and specifies the output voltage Vsup to each of the step-down power supplies 41 through the DAC 43. The step-down power supplies 41 are installed in order to restrain ripple noise and adjust power supply voltages to the actuator units 31 (i.e. Vsup).

Correspondingly to natural vibration frequencies of the actuator units 31, the step-up DC/DC switching converter 11 of the video circuit board 2 operates with a switching frequency different from the natural vibration frequencies of the actuator units 31. For example, the step-up DC/DC switching converter 11 operates with a switching frequency higher than the natural vibration frequencies of the actuator units 31. In such a case, ripple noise is restrained more effectively.

For example, it is favorable that if the natural vibration frequency of the actuator unit 3 is 2 MHz, the switching frequency is set outside of a resonance range 1.6 MHz to 2.4 MHz including this 2 MHz, i.e. is set as a frequency that is less than a lowermost frequency of the resonance range or exceeds an uppermost frequency of the resonance range, and also set as a maximum frequency that can be set.

Further, if the actuator unit 31 is exchanged and thereby the natural vibration frequency changes, then correspondingly to the natural vibration frequency of the exchanged actuator unit 31, the e switching frequency is adjusted so as to be different from the natural vibration frequency of the exchanged actuator unit 31, if required.

The following part explains a behavior of aforementioned image forming apparatus.

As mentioned, the main circuit board 1 generates image data of a page image, and the video circuit board 2 supplies to the head unit 3 a video signal corresponding to the image data and thereby causes it to eject ink.

Further, in the video circuit board 2, the controller 12 sets a switching frequency to the step-up DC/DC switching converter 11 such that the switching frequency is different from natural vibration frequencies of the actuator units 31 in the head units 3. The step-up DC/DC switching converter 11 operates with the switching frequency set by the controller 12, and supplies direct-current electric power to the head units 3 with an output voltage Vo set by the controller 12.

In the head unit 3, direct-current electric power is supplied to the actuator unit 31 with a voltage Vsup corresponding to the actuator unit 31 through the step-down power supplies 41. The actuator unit 31 operates the piezoelectric element 51 correspondingly to a page image in accordance with the aforementioned video signal and thereby causes it to eject ink.

As mentioned, in the aforementioned embodiment, the head unit 3 includes the actuator unit 31 to eject ink; and in the video circuit board 2, the step-up DC/DC switching converter 11 operates with a switching frequency set by the controller 12 and supplies direct-current electric power to the head unit 3. Further, the step-up DC/DC switching converter 11 operates with the switching frequency different from a natural vibration frequency of the actuator unit 31.

Consequently, even if small noise of the same frequency as the switching frequency mixes, then the actuator unit 31 does not vibrate with the natural vibration frequency of the actuator unit 31, and therefore, in the piezoelectric element 51, restrained is malfunction due to the switching frequency of the switching power supply (the step-up DC/DC switching converter 11) that supplies electric power to the head unit 3.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiment, a non-volatile storage device (flash memory or the like) may be installed (in the head unit 3) to store a natural vibration frequency of the actuator unit 31 (as data), and the controller 12 may read the natural vibration frequency from this storage device, and set a switching frequency to the step-up DC/DC switching converter 11 such that the switching frequency is different from the read natural vibration frequency of the actuator unit 31.

Further, in the aforementioned embodiment, a non-volatile storage device (flash memory or the like) may be installed (in the head unit 3) to store a natural vibration frequency of the actuator unit 31 (as data), and the controller 12 may read the natural vibration frequency from this storage device, and if the read natural vibration frequency of the actuator unit 31 is substantially identical to the switching frequency of the step-up DC/DC switching converter 11, then the controller 12 may output a warning. In a case that the step-up DC/DC switching converter 11 can not be adjusted, if the read natural vibration frequency is substantially identical to the switching frequency of the step-up DC/DC switching converter 11, then the warning is outputted. As the warning, a warning message is displayed on an operation panel (not shown), for example. Further, in such a case, the image forming apparatus may be prevented from a printing operation.

What is claimed is:

1. An image forming apparatus, comprising:
a head unit configured to eject ink; and
a switching power supply configured to supply electric power to the head unit;
wherein the head unit comprises an actuator unit to eject ink; and
the switching power supply operates with a switching frequency different from a natural vibration frequency of the actuator unit.

2. The image forming apparatus according to claim 1, wherein the switching power supply operates with a switching frequency higher than the natural vibration frequency of the actuator unit.

3. The image forming apparatus according to claim 1, further comprising a storage device configured to store the natural vibration frequency of the actuator unit, and a controller;
wherein the controller reads the natural vibration frequency of the actuator unit from the storage device and sets the switching frequency to the switching power supply such that the set switching frequency is different from the read natural vibration frequency.

4. The image forming apparatus according to claim 1, further comprising a storage device configured to store the natural vibration frequency of the actuator unit, and a controller;
wherein the controller reads the natural vibration frequency of the actuator unit from the storage device, and if the read natural vibration frequency is substantially identical to the switching frequency to the switching power supply, outputs a warning.
